(19) United States
(12) Patent Application Publication
(10) Pub. No.: US 2015/0252448 A1
(43) Pub. Date: Sep. 10, 2015

(54) PRODUCTION OF HIGH-GRADE SYNTHETIC RUTILE FROM LOW-GRADE TITANIUM-BEARING ORES

(71) Applicant: Fouad F. KAMALEDDINE, Toronto (CA)

(72) Inventor: Fouad F. KAMALEDDINE, Toronto (CA)

(21) Appl. No.: 14/634,434

(22) Filed: Feb. 27, 2015

Related U.S. Application Data
(60) Provisional application No. 61/948,319, filed on Mar. 5, 2014.

(51) Int. Cl. C22B 34/12; B01D 3/36; C01G 49/02; C22B 3/10; C22B 34/22; C22B 34/32

(52) U.S. Cl. CPC C22B 34/1245; C22B 34/22; C22B 34/32; C01G 49/02; C22B 3/10; B01D 3/36

(57) ABSTRACT

The present invention relates to a two-stage leaching process using concentrated hydrochloric acid that upgrades a variety of inferior quality titanium-iron ores into premium titanium concentrate and iron oxide products. The ground ore is leached with two separate quantities of hydrochloric acid after which the dissolved titanium is precipitated from the filtered liquor by hydrolysis. The still soluble iron chlorides are then optionally subjected to oxyhydrolysis to recover iron oxide and HCl. The process was developed for low-grade ores (under 12% TiO₂), and can be naturally applied advantageously to higher grade titanium-bearing ores.

### BACKGROUND

1. Field of the Disclosure

The present invention generally relates to a two-stage leaching process using concentrated hydrochloric acid that upgrades a variety of inferior quality titanium-iron ores into premium titanium concentrate and iron oxide products.

2. Description of the Related Art

High-grade synthetic rutile is an excellent feed material for fluid bed chlorination, and is also a good feedstock for making either pigment or titanium sponge.

The gradual depletion of rutile-type concentrates has given impetus to research new methods of producing improved concentrates from low-grade ores, which could be used advantageously as substitutes. Many processes presently investigated by the industry give preference to the removal of iron by chemical or physical methods, while leaving the titanium in the undesirable gangue material. The QIT process is an example of this upgrading. In this process, a 40% TiO₂ ilmenite ore is upgraded to 70% TiO₂ slag after high temperature reactions. These processes produce a cheaper concentrate, but they are limited because the starting material must be a high-grade ilmenite containing 40-50% of TiO₂. Accordingly, the product obtained, while being relatively free of certain elements, is easily chlorinated in a fluidized bed.

Several conventional hydrometallurgical processes were developed that involve leaching of iron from ilmenite to obtain a residue rich in titanium (90-95% TiO₂) known as “synthetic rutile”.

The following diagram shows a conventional hydrometallurigical process for the production of synthetic rutile from high-grade ilmenite.

As shown in the above diagram, high-grade ilmenite is decomposed in autoclaves by 20% HCl at 120° C. and 200 kPa, and iron is solubilized as ferrous chloride leaving a solid containing about 93% TiO₂ as shown in the following Formula 1.

FeTiO₃+2H⁺→TiO₂ [impure]+Fe²⁺+H₂O Formula 1:

The synthetic rutile is then treated with chlorine to prepare TiCl₄ from which TiO₂ or titanium metal is obtained without pollution problems. The ferrous chloride solution is then regenerated to HCl and Fe₂O₃ by oxyhydrolysis by the following Formula 2:

2FeCl₂+2H₂O+½O₂→Fe₂O₃+HCl Formula 2:

Modifications for this technology were introduced as shown in Table 1. However, the drawback of these conventional processes is that they are not suitable for low-grade ilmenite containing under 15% TiO₂ due to the presence of silicate gangue that remains in the synthetic rutile. Rather, the conventional processes are applicable only for high-grade ilmenite containing 30-50% TiO₂. The presence of silicate gangue in the synthetic rutile decreases its tenor in titanium.

TABLE 1
Production plants for synthetic rutile

| Process | Process steps | By-products | Producer and location |
|---|---|---|---|
| Benilite | Partial reduction to | FeCl₂ pyrolyzed | Kerr McGee, Mobile, USA |
| Corporation | Fe (II), digestion | to Fe₂O₃ and HCl | Kerala, Minerals and |
| of America | with HCl solution, | | Metals Ltd., Chavara, |
| | calcination | | Kerala |
| | | | Indian Rare Earths, |
| | | | Orissa, India |
| Western | Oxidation to Fe (III), | Iron hydroxides | Associated Minerals |
| Titanium | reduction to Fe, | | Consolidated Cael, |
| | digestion with FeCl₂, | | Australia |
| | with air oxidation | | AMC, Narngulu, |
| | | | Australia |
| Lurgi | Reduction to Fe, | Iron hydroxides | Westralian Sand Ltd., |
| | digestion with air | | Capel, Australia |
| | blowing, hydrocyclone | | |
| | separation, calcination | | |
| Ishibara | Reduction to Fe (II), | FeSO₄ solution | Ishibara, Yokkaichi |
| Sangyo | digestion with H₂SO₄, | reacted with NH₃ | Japan |
| Kaisha | calcination | to form ammonium | |
| | | sulfate and iron | |
| | | hydroxide | |
| Dhrangadhra | Reduction to | Iron chloride | Dhrangadhra Chemical |
| Chemical | Fe(II)/Fe, digestion | solution | Works Ltd., Suhupuram, |
| works | with HCl, calcination | | Tamil Nadu, India |

There have also been attempts to produce pigment directly from ilmenite. Pigment is defined as a powdered substance that is mixed with a liquid in which it is relatively insoluble and used especially to impart color to coating materials (as paints) or to inks, plastics, and rubber. TiO₂ pigment is the most important white pigment used in the coatings industry. It is widely used due to the unique combination of its superior properties, including high refractive index, low specific gravity, high hiding power and opacity, and non-toxicity.

For instance, U.S. Pat. No. 6,375,923, U.S. Pat. No. 7,803,336, and U.S. Pat. No. 2,167,628 describe hydrometallurgical processes that involve digestion of the ore in a mineral acid, such as hydrochloric acid or sulphuric acid, to extract value metals, including titanium dioxide from the ore. Another notable drawback of each of the previously noted processes is that they require a purification step of the leach solution prior to TiO₂ recovery, either by reduction of the existing ferric iron to its ferrous state, or by a separate solvent extraction step to recover the titanium in a more pure form.

### BRIEF SUMMARY OF THE INVENTION

Therefore, the present invention has been made in order to solve one or more of the above problems. It is an object of the present invention to provide a method that produces a high-grade synthetic rutile from ilmenite, particularly from low-grade ore, that is widely available. The high-grade synthetic rutile produced in the present invention preferably contains 95-98% TiO₂, with 98% TiO₂ being the most preferable amount. For example, it is an object of the present invention to produce a high-grade synthetic rutile from the Magpie deposits containing about 11% TiO₂, which are abundantly available in the Province of Quebec, Canada. However, any low-grade ore containing under 20% TiO₂ can be used. Preferably, the low-grade ore contains 10-20% TiO₂, with 20% TiO₂ being the most preferable amount. However, it should be appreciated that the present invention is not limited to Magpie deposits containing 11% TiO₂, and could encompass any deposit, including in Canada Lac Lablache and Lac Brulé (Quebec), Pipestone Lake (Manitoba), and others. In addition, the process can be naturally applied advantageously to higher grade titanium bearing ores and concentrates.

Another object of the present invention is to provide a method of extraction that has the advantage of being applicable to many iron-titanium ores, regardless of the percentage of gangue minerals, provided that these are not carbonates or other high acid consumers. Iron-titanium ores used in the present invention can be obtained from deposits like Balla Balla (Australia), Panzhua (China), Abu Ghalaga (Egypt), Itaituba (Brazil), along with many other newly discovered deposits in Russia.

According to another aspect of the present invention, the process for the recovery of high-grade synthetic rutile involves leaching ground ore with two separate quantities of hydrochloric acid after which the dissolved titanium is precipitated from the filtered liquor by hydrolysis. The soluble iron chlorides are either hydrolyzed in turn, or reduced to metal and hydrochloric acid. However, the present invention is not limited to hydrochloric acid, and may include other hydrogen halides (where halide by definition refers to flourine, chlorine, bromine, or iodine).

According to yet another aspect of the present invention, unreacted hydrochloric acid is recovered and iron or iron oxide is produced following the process for the recovery of high-grade synthetic rutile.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an illustration of the process flow sheet with a two-step leaching process.

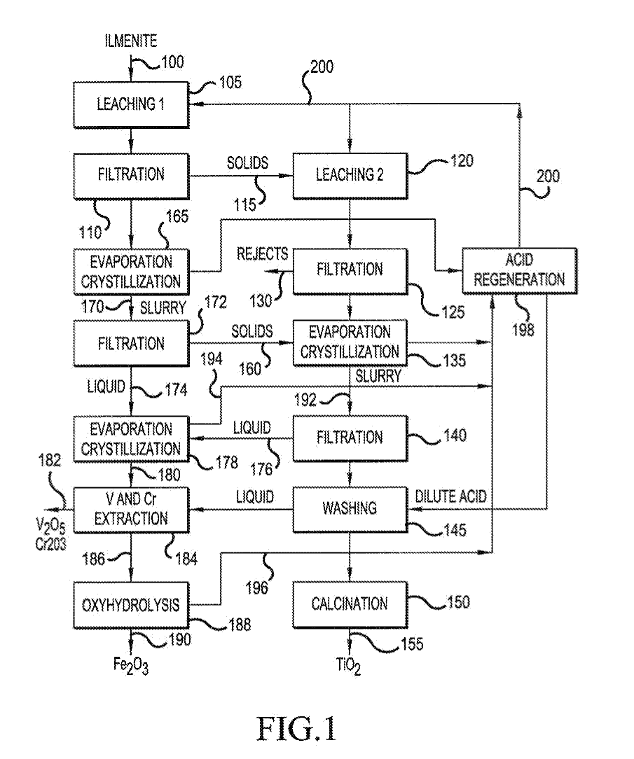

FIG. 2 is an illustration of the process flow sheet with a one-step leaching process.

### DETAILED DESCRIPTION OF THE EMBODIMENTS

Hereinafter, the present invention will be described in detail.

The present invention provides a two-step leaching process for the recovery of high-grade synthetic rutile from low-grade ores, which include but are not limited to the following steps:

(a) performing a first leaching reaction (105) by contacting the low-grade ores (100) with 35-40% hydrochloric acid (200) at an acid to ore ratio of between 2-2.5, and at a temperature of 60-70° C. to obtain a slurry;

(b) filtering (110) a filter cake (115) from the slurry obtained in step (a);

(c) performing a second leaching reaction (120) by contacting the solid (115) obtained in step (b) with fresh 35-40% hydrochloric acid (200) at an acid to solid ratio of 2-2.5, and at a temperature of 75-80° C.; and

(d) filtering (125) the product obtained in step (c) to remove a residue (130) of alumina and silica.

The recovery of the free unreacted acid is made by mixing the two filtered solution (174) from the first leaching process (105) and (176) from the second leaching process (120), and distilling off hydrochloric acid (194) and water until the titanium is hydrolyzed (135) and substantial part of the iron chlorides precipitate as hydrates (178). Filtering removes the residual saturated liquor (140).

The chloride crystals are dissolved with a minimum of dilute acid (145) leaving the insoluble TiO(OH)₂ as a finely divided granular solid which filters very easily.

After performing a calcining process (150) the product contains 98% TiO₂ (155), less than 1.5% Fe₂O₃, 0.06% CaO and 0.02% Mgo, 0.1% SiO₂, and 0.07% Al₂O₃. Thus, the synthetic rutile composition obtained would be an excellent feed material for fluid bed chlorination, and a good feedstock for making either pigment or titanium sponge. The calcining process is a thermal decomposition of a material (see Fathi Habashi, Textbook of Pyrometallurgy. Quebec City, Canada: Métallurgie Extractive Québec, 2002). In the present invention, the calcining process involves the decomposition of titanyl-hydroxide (TiO(OH)₂) to titanium dioxide (TiO₂) and water vapor.

The high-grade synthetic rutile produced from the two-step leaching process has an amount of titanium oxide in the range of 95-98% TiO2. The high-grade synthetic rutile produced preferably contains 95-98% TiO₂, with over 98% TiO₂ being the most preferable.

The high-grade synthetic rutile produced in the present invention may further include a pre-leaching step by contacting a low-grade ilmenite with dilute hydrochloric acid to remove a substantial amount of the phosphorus content therefrom. The initial amount of phosphate (P₂O₅) in the ore (feed) is in the range of 0.12-0.15%. The amount of phosphate in the final TiO₂ product is in the range of 1.8-2.1%. Preferred phosphate content in the product is under 0.05%. Conducting the pre-leaching step results in a product with a P₂O₅ content under 0.05%.

The low-grade ilmenite ore deposits are not limited. The low-grade ore deposits may include any amount of TiO₂. Any ore having under 20% TiO₂ is considered low-grade ilmenite, with the range 10-12% TiO₂ being preferable, and over 12% TiO₂ being the most preferable. Further, the deposits may be obtained anywhere in which low-grade ores are found, and thus, the invention is not limited thereto.

In the process of the present invention, a titanium dioxide precipitator may be used. A titanium dioxide precipitator comprises a heater for boiling the leach solution to liberate free hydrochloride via the hydrochloride acid outlet and a means of collecting and discharging the precipitated titanium dioxide slurry.

In the process of the present invention, a TiO₂ free filtrate solution (180) may be further treated to recover vanadium and chromium (184). Recovery of vanadium and chromium (184), involves either solvent extraction or selective precipitation.

In the process of the present invention, the chloride solution, free of titanium, vanadium, and chromium, may be fed to a spray-type reactor where high temperature hydrolysis in a slightly oxidizing atmosphere (188) produces iron oxide (190) and hydrochloric acid (196).

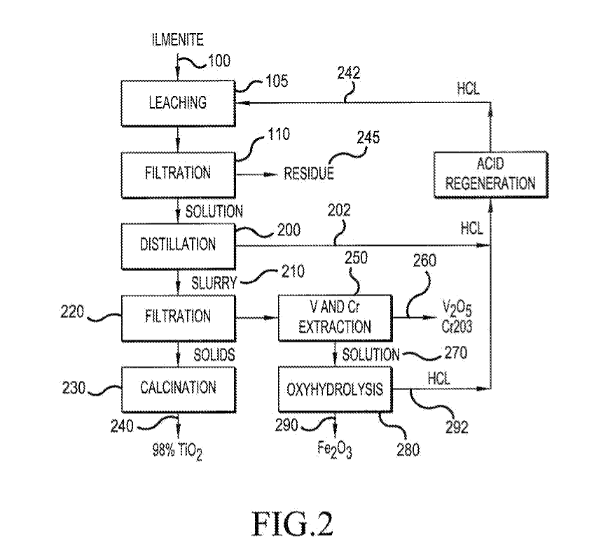

In addition, as illustrated in FIG. 2, the present invention provides a one-step leaching process (105) for the recovery of high-grade synthetic rutile from low-grade ores (100), which includes but is not limited to the following steps:

contacting low-grade ores (100) with 37% hydrochloric acid (242) at a fixed acid to ore ratio of 6.1 to produce a high residual acid concentration to prevent the hydrolysis of the titanium.

In this one-step leaching process (105), an agitated tank at 75° C. may be used at an ambient pressure with concentrated 37% hydrochloric acid (242) that has an acid to ore ratio of 6.1. These conditions dissolve all of the iron and titanium. After filtration (110) to remove the silicate gangue minerals, the solution is subjected to distillation (200) to expel excess hydrochloric acid (202).

During the one-step leaching process (105), titanyl-hydroxide and TiO(OH)₂, precipitate, but not iron. After solid-liquid separation by a second filtration step (220), vanadium and chromium can be extracted (250) by organic solvents, while ferrous chloride solution (270) is then subjected to oxyhydrolysis (280) to recover Fe₂O₃ (290) and hydrochloric acid (292).

Thereafter, calcination (230) of titanyl hydroxide results in a product containing about 98% TiO₂ (240) at 98.2% recovery.

Having thus described in detail various embodiments of the present invention, it is to be understood that the invention defined by the above paragraphs is not to be limited to particular details set forth in the above description as many apparent variations thereof are possible without departing from the spirit or scope of the present invention.

Hereinafter, the present invention will be described in detail through using manufacturing examples and embodiments. The after-mentioned detailed descriptions are just exemplified in order to help understanding the present invention. However, the present invention is not limited thereto.

### Example 1

### Dissolution of Low-Grade Ore (Containing 11% TiO₂) from the Magpie Deposits in the Province of Quebec, Canada, and the Removal of Insoluble Materials

First Stage:

a. The low-grade ore is finely ground to 200 mesh with preferable and more preferable ranges of 50% and 80% passing minus 200 mesh, respectively.

b. A first leaching reaction is made by contacting the low-grade ore with hydrochloric acid that has a concentration in the range of 35-40%, and using an ore to acid ratio of between 2 to 2.5. Due to the pulp density and the fine granulometry, only slight stirring is required to prevent sedimentation. This first leaching reaction dissolves the magnetite in approximately one hour. The temperature is held at 60-70° C.

c. The pregnant liquor, now containing only 2-4% HCl, is preferably replaced with fresh concentrated acid to dissolve ilmenite and the titanium present in the ore to obtain a slurry. The slurry is then filtered, and the solid, without washing, is sent to a second leaching reaction.

d. A second leaching reaction is conducted by adding fresh acid, which has a concentration in the range of 35-40%, to a filter cake at a ratio of between 2 to 2.5, respectively. The reaction lasts another hour, and the temperature is held at 75-80° C. The residue is removed by a second filtration process, and washed.

Due to its porous structure, washing cannot remove all of the occluded solution. Accordingly, an optional step is to dry this waste at high temperatures to remove all of the acid. Prior to drying, the losses in free HCl amount to about 0.1 ton per ton or ore leached. Non-recoverable losses, due to the solution which cannot be removed, amount to 1.4-1.6% of the total iron and 4-4.5% of total TiO₂. If the non-soluble iron and titanium are taken into account, the total recovery is about 95% for iron and 90% for titanium.

The sequential steps of leaching-filtrating-leaching enhance the dissolution of the ilmenite. The iron oxide minerals respond much more rapidly to the HCl leach than the titanium minerals. Under these conditions, the solution from the first leach contains much more iron and only a small quantity of titanium. At this stage of the process, 70% of the total iron and 30% of the titanium oxide are leached into solution after the first stage. The small quantity of titanium is attributed to the dissolution of titanium minerals at the beginning of the leach when the hydrochloric acid concentration is high, but as the acid concentration diminishes, the dissolution of the titanium minerals slows down, and may undergo hydrolyzation.

Controlling the temperature during the first leach has a double purpose: (1) it reduces the dissolution of titanium, and (2) it reduces the hydrolysis of what little titanium is dissolved.

The addition of fresh acid in the second leaching reaction allows the dissolution of the remaining iron and titanium minerals. The acid concentration is not as markedly reduced as in the first leaching reaction, thereby holding the titanium in solution even at about 60° C.

### Example 2

### The Precipitation of TiO(OH)₂ by the Distillation of the Unreacted Acid

Second Stage:

The two leaching reactions discussed in Example 1 consume more than one-half of the available acid. The recovery of the free unreacted acid is performed by mixing the two filtered solutions obtained from the first and second leaching reactions discussed in Example 1, and distilling off hydrochloric acid and water until the titanium is hydrolyzed and a substantial part of the titanium chlorides precipitate as hydrates. About 90% of the titanium chlorides precipitate as hydrates. Another filtering step removes the residual saturated liquor.

The chloride crystals are dissolved with a minimum amount of dilute acid leaving behind an insoluble TiO(OH)₂ in the form of a finely divided granular solid, which filters easily. After the calcining process, the high-grade synthetic rutile contains an amount of TiO₂ in the range of 95-98% TiO₂, which meets the requirements of synthetic rutile concentrates.

### Example 3

### The Recovery of Bound Hydrochloric Acid and the Production of Iron or Iron Oxide

Third Stage:

There are several possible ways to recover iron and the bound hydrochloric acid, these include:

1. The ferric chloride is reduced with iron and the solution is partly evaporated to crystallize hydrated ferrous chloride, which can then be reduced to metal by hydrogen to produce iron powder.

2. The chloride solution is fed to a spray-type reactor in an atmosphere of hydrogen at high temperature. Iron powder is produced, along with the simultaneous regeneration of hydrochloric acid and the evaporation of water. The iron produced contains 0.4% TiO₂ and 1-3.5% Cr₂O₃.

3. The chloride solution is fed to a spray-type reactor where high temperature hydrolysis in a slightly oxidizing atmosphere produces iron oxide and hydrochloric acid.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A process for the recovery of high-grade synthetic rutile from low-grade ores, which comprises:
(a) performing a first leaching reaction by contacting the low-grade ores with 35-40% hydrochloric acid at an acid to ore ratio of between 2-2.5, and at a temperature of 60-70° C. to obtain a slurry;
(b) filtering a filter cake from the slurry obtained in step (a);
(c) performing a second leaching reaction by contacting the solid obtained in step (b) with 35-40% hydrochloric acid at an acid to solid ratio of 2-2.5, and at a temperature of 75-80° C.; and
(d) filtering the product obtained in step (c) to remove a residue of alumina and silica.

2. The process according to claim 1, wherein the high-grade synthetic rutile is 95-98% TiO₂.

3. The process according to claim 2, wherein the high-grade synthetic rutile is 98% TiO₂.

4. The process according to claim 1, wherein the low-grade ores are composed of less than 12% TiO₂.

5. The process according to claim 1, wherein the ore is ground to 80% minus 200-mesh prior to the step (a).

6. The process according to claim 1, wherein steps (a) and (c) have a concentration of 37% hydrochloric acid, and have a fixed acid to ore ratio of 2.37.

7. A process to recover free unreacted hydrochloric acid from claim 1, comprising:
mixing the two filtered solutions obtained in steps (a) and (d);
distilling off the hydrochloric acid until the titanium is hydrolyzed and a substantial part of the iron chlorides precipitate as hydrates.

8. The process according to claim 7, wherein a precipitator, which comprises a heater, boils the filtered solutions to liberate free HCl via the HCl acid outlet and a means of collecting and discharging a precipitated titanium dioxide slurry.

9. The process according to claim 7, wherein a titanium dioxide free solution is further treated to recover vanadium.

10. The process according to claim 7, wherein a titanium dioxide free solution is further treated to recover chromium.

11. The process according to claim 7, wherein the iron chloride precipitate, free of titanium, vanadium, and chromium, is fed to a spray-type reactor to undergo high temperature hydrolysis in a slightly oxidizing atmosphere to produce iron oxide and hydrochloric acid.

12. The process according to claim 1, further comprises a pre-leaching step by contacting the low-grade ores with dilute hydrochloric acid to substantially remove the phosphorus content therefrom.

13. A process for the recovery of high-grade synthetic rutile from low-grade ores comprising:
(a) performing a one-step leaching reaction by contacting the low-grade ores with 37% hydrochloric acid at a fixed acid to ore ratio of 6.1 to produce a high residual acid concentration to prevent the hydrolysis of the titanium.

14. The process according to claim 13, wherein the high-grade synthetic rutile is 98% TiO2.

15. The process according to claim 13, further comprising:
(b) filtering residue from the slurry obtained in step (a);
(c) distilling off the hydrochloric acid;
(d) performing a second filtering step from the slurry (210) obtained in step (c) to recover a high grade titanium dioxide.

16. The process according to claim 15, wherein a titanium dioxide free solution obtained in step (d) is further treated to recover vanadium.

17. The process according to claim 15, wherein a titanium dioxide free solution obtained in step (d) is further treated to recover chromium.

18. The process according to claim 15, wherein the iron chloride precipitate, free of titanium, vanadium, and chromium, is fed to a spray-type reactor to undergo high temperature hydrolysis in a slightly oxidizing atmosphere to produce iron oxide and hydrochloric acid.

19. The process according to claim 13, further comprises a pre-leaching step by contacting the low-grade ores with dilute hydrochloric acid to substantially remove the phosphorus content therefrom.
